(19) United States
(12) Patent Application Publication
(10) Pub. No.: US 2025/0110715 A1
(43) Pub. Date: Apr. 3, 2025

(54) Binary Code Similarity Detection System Based on Hard Sample-aware Momentum Contrastive Learning

(71) Applicant: SHANGHAI JIAO TONG UNIVERSITY, Shanghai (CN)

(72) Inventors: Futai ZOU, Shanghai (CN); Bolun WU, Shanghai (CN); Liang ZHANG, Shanghai (CN); Yue WU, Shanghai (CN)

(21) Appl. No.: 18/376,112

(22) Filed: Oct. 3, 2023

(51) Int. Cl. G06F 8/41

(52) U.S. Cl. CPC G06F 8/433

(57) ABSTRACT

The present disclosure provides a binary code similarity detection system based on hard sample-aware momentum contrastive learning, comprising: a preprocessing device for transforming the binary code into tokens for neural networks; a feature extracting device for using the tokens to generate final representation embeddings for the binary code; and a similarity detection device for using the representation embeddings to detect the binary code similarity.

### TECHNICAL FIELD

The present disclosure belongs to the technical field of information detection technology and relates to a binary code similarity detection system.

### BACKGROUND

Binary code similarity detection (BCSD) is the technique to determine whether two binary code snippets (i.e., binary function) is similar, which plays an important role in a wide range of applications in security fields, such as malware classification, software component analysis, and known vulnerability discovery. This task is highly challenging due to the diverse compilation environments in real-world software. Compiling software involves various factors such as different compilers, compiler versions, compiler optimizations, and target architectures. Consequently, the same source function can be compiled into vastly different binary functions, posing a significant hurdle in detecting similarity solely from the binary code.

Recently, the rapid advancements in machine learning (ML) techniques have led to the proposal of various ML-based approaches to address BCSD. These ML based solutions typically adopt a contrastive learning framework. Specifically, a binary function representation model is trained to learn an embedding space, where the embedded vectors of similar samples are encouraged to be closer, while dissimilar ones are pushed further apart. Prior works have made efforts to design effective models. Some works utilize natural language processing (NLP) techniques to model the assembly instructions. Other works employ graph neural networks (GNNs) to learn the representation of control flow graphs (CFGs). Furthermore, certain studies leverage combined models that use NLP to extract basic block features and then generate CFG embeddings using GNNs. Despite their impressive performance, existing ML-based BCSD methods suffer from several limitations.

Firstly, while these works make efforts to design proper function embedding models, they all train models on randomly sampled pairs and optimize with contrastive or triplet loss. However, recent studies in the field of contrastive learning have revealed that constructing pairs from training samples results in a large amount of highly redundant and less informative pairs. Consequently, models trained with random sampling can be overwhelmed by these redundant pairs, leading to slow convergence and inferior performance. Therefore, it is essential to introduce a more effective training strategy in this domain.

Secondly, most current works focus on CFGs or instruction sequences of binary functions, which change vastly due to various compilers and optimizations. As a result, these methods suffer from performance degeneration in scenarios where similar functions are compiled with different compilers and optimizations. The function's call graph (CG) structure should be considered as well since it is more stable across different compilation configurations. Though αdiff considers function's in-degree and out-degree in the CG, it fails to fully capture the rich structural information present in CGs and the interactive semantics with other functions.

### SUMMARY

In view of the above defects of the prior art, the present application provides a binary code similarity detection system based on hard sample-aware momentum contrastive learning, comprising:
a preprocessing device for transforming the binary code into tokens for neural networks;
a feature extracting device for using the tokens to generate final representation embeddings for the binary code; and
a similarity detection device for using the representation embeddings to detect the binary code similarity.

The technical effects of the present disclosure include the follows.

The binary code similarity detection system provided in the present disclosure can significantly outperforms state-of-the-art (SOTA) solutions. Specifically, in the task of searching for the only similar function among 1,000 functions with different compilers, compiler optimizations, and architectures on the BFS dataset, the system produces the highest similarity score for the correct function (Recall@1) with a probability of 80.5%, which improves the best score 45.2% of SOTA methods by a large margin. Moreover, in a real-world known vulnerability search task, the system achieves the best Recall@5 scores on all of the selected CVEs. Furthermore, the training strategy can be seamlessly integrated into existing contrastive learning-based baselines, leading to significant performance improvements.

In the following contents, the concept, specific structure and technical effect of the present disclosure will be further described in combination with the drawings, so as to fully understand the purpose, features and effect of the disclosure.

### BRIEF DESCRIPTION OF THE DRAWINGS

FIG. 1 is a schematic diagram showing the structure of binary code similarity detection system in a preferred embodiment of the present disclosure.

FIG. 2 is a schematic diagram showing the structure of feature extracting device in the binary code similarity detection system as shown in FIG. 1.

FIG. 3 is a schematic diagram showing the input representation of Transformer Encoder in the binary code similarity detection system as shown in FIG. 1.

FIG. 4 is a schematic diagram showing one layer propagation of GatedGCN in the binary code similarity detection system as shown in FIG. 1.

FIG. 5 is a schematic diagram showing one layer propagation of GIN in binary code similarity detection system as shown in FIG. 1.

FIG. 6 is a schematic diagram showing MRR at different pool sizes of different BCSD methods on BINKIT dataset.

FIG. 7 is a schematic diagram showing MRR at different pool sizes of different BCSD methods on BFS dataset.

### DETAILED DESCRIPTION OF THE PREFERRED EMBODIMENTS

Several preferred embodiments of the present disclosure are described with reference to the drawings of the specification, so that the present disclosure is clearer and easier to be understood. The present disclosure can be realized by many different forms of embodiments, and the protection scope of the present disclosure should not be limited to the embodiments mentioned herein.

In the drawings, the same components are represented by the same reference numbers, and the components with similar structure or function are represented by the similar reference numbers. The size and thickness of each component shown in the drawings are arbitrarily shown, and the present disclosure does not limit the size and thickness of each component. In order to make the drawings clearer, the thickness of the parts is appropriately exaggerated in some places in the drawings.

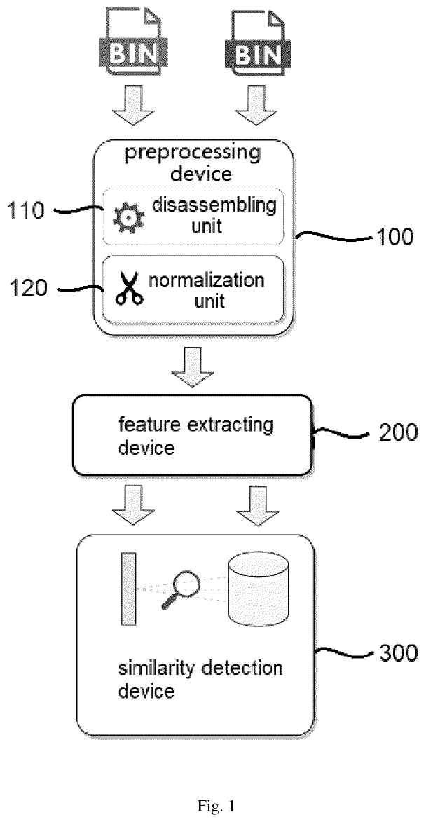

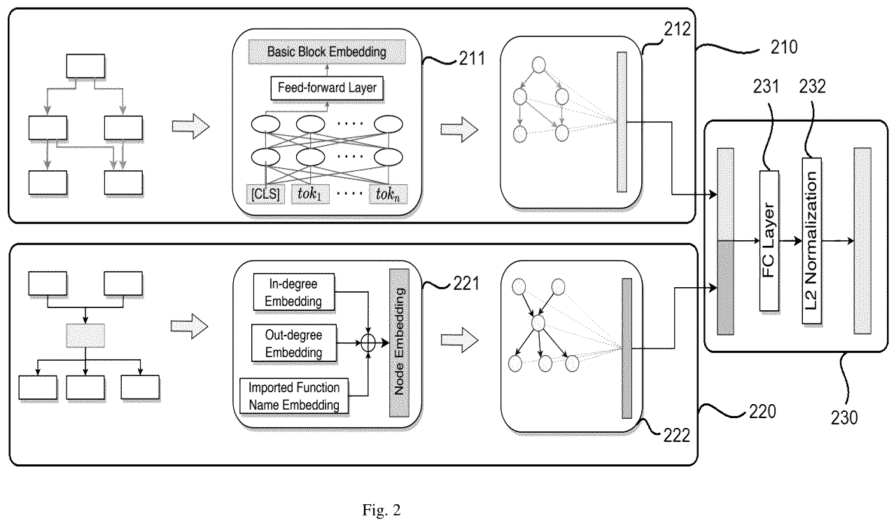

FIGS. 1 and 2 show the structure of binary code similarity detection system in a preferred embodiment of the present disclosure. As shown in FIGS. 1 and 2, the binary code similarity detection system provided in the present embodiment comprises a preprocessing device 100, a feature extracting device 200 and a similarity detection device 300. The preprocessing device is used for transforming the binary code into tokens for neural networks, and comprises a disassembling unit 110 and a normalization unit 120, wherein the disassembling unit 110 is used for disassembling the binary code to generate assembly tokens, and the normalization unit 120 is used for performing normalization to the assembly tokens to avoid out-of-vocabulary problem. The feature extracting device 200 is used for using the tokens to generate final representation embeddings for the binary code, and comprises a CFG features 210, a CG features extractor 220 and a features combiner 230, wherein the CFG features extractor 210 is used for using tokens to extract features of control flow graph, the CG features extractor 220 is used for using tokens to extract features of call graph, and the features combiner 230 is used for combining the features of control flow graph and call graph to generate the representation embeddings for the binary code. The CFG features extractor 210 comprises a transformer encoder unit 211, which is used for extracting semantic features to generate a vectorized CFG, and a CFG feature encoder unit 212, which is used for converting the vectorized CFG into a vector representation. The CG features extractor 220 comprises a node feature encoder unit 221, which is used for generating node embeddings, and a CG subgraph feature encoder unit 222, which is used for extracting the subgraph's vector representation. The features combiner 230 is used for combining the features of control flow graph and call graph to generate the representation embeddings for the binary code, and comprises a fully-connected layer 231 and an L2 normalization operation unit 232.

The binary code similarity detection system provided in the present embodiment first preprocesses the input binary function to make it compatible with the neural networks. Then, a binary function representation model trained with the hard sample-aware momentum contrastive learning strategy is utilized to generate function embeddings. The model extracts features from both CFG and CG by employing CFG modeling and CG modeling. Finally, in a one-to-many (OM) binary function search scenario, the similarity between the vector representation of the target function and all vectors in the function pool are calculated in order to identify similar functions.

### Preprocessing Device

The preprocessing device aims to transform binaries into formats suitable for feeding into neural networks. It involves two main tasks: disassembling and instruction normalization.

Radare2 is used to disassemble the binary file, extract the call graph (CG) and control flow graphs (CFGs) of all functions.

Directly using assembly instructions as input for neural networks poses an out-of-vocabulary (OOV) problem due to the large number of vocabularies present in binary code. To address this, instruction normalization is performed, which converts an instruction into a sequence of tokens as follows:
(i) regular expression (\W) is used to split each instruction into fine-grained tokens (e.g., “add”, “+”, “[”);
(ii) string literals are replaced with a special token <str>;
(iii) For constant numbers, if the constant is at least five digits in hexadecimal, it is replaced with a special token <addr>, and if the constant is less than four digits in hexadecimal, it is converted into decimal form and keep it as a token; otherwise, the constant is converted into a special token <const>.

To enhance the model's understanding of assembly tokens, a token type is assigned to each token. The mnemonic and operand types defined in Radare2 (e.g., “reg”, “imm”, “jmp”) are assigned to the corresponding tokens. It's important to note that in cases where an operand is split into multiple tokens, all of these tokens share the same type as their parent operand.

As an example for the above normalization process, the instruction “add x1, x0, 0x310” is transformed into a sequence of four tokens: “add”, “x1”, “x0”, “784”. Their token types are “add”, “reg”, “reg”, and “imm”, respectively.

### Feature Extracting Device

To address the limitation of CFG-based methods, the binary code similarity detection system provided in the present embodiment takes a broader perspective by also leveraging the structural features from CG. Specifically, as illustrated in FIGS. 1 and 2, the binary code similarity detection system provided in the present embodiment employs two dedicated neural networks to extract features from both CFG and CG subgraph. Then, a feature fusing component is employed to merge the two representations into a final representation that captures the combined information.

Regarding Control Flow Graph Modeling, in the CFG modeling phase, a Transformer Encoder is used to extract semantic features for each basic block (i.e., the node of CFG). Then, edge embeddings are computed and the GatedGCN in conjunction with a pooling layer is used to convert the vectorized CFG into a vector representation.

Regarding Transformer Encoder, as described above, each instruction is converted into tokens. By concatenating the tokens from all instructions within a basic block, the basic Block is transformed into a sequence of tokens. A special token <CLS> is provided at the beginning for computing the basic block embedding. Additionally, a maximum length m is defined for basic blocks, either truncating those surpassing this limit or padding them with the special token <PAD> to ensure a consistent length of m tokens.

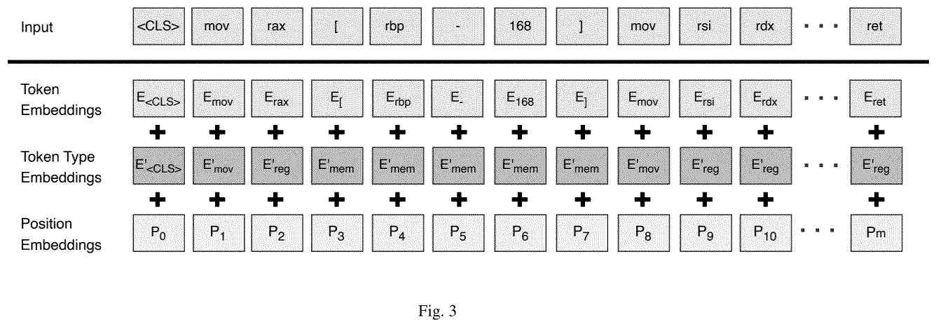

Next, the input representation of the Transformer Encoder is constructed as depicted in FIG. 3. Similar to the original Transformer architecture, the input encompasses token embeddings and position embeddings, which enables the model to determine the distance between tokens. Furthermore, embeddings of token types introduced above are incorporated to enhance the model's comprehension of assembly tokens.

The input representations H⁰∈R_{m×d} are then fed into N transformer layers to generate contextual representations of tokens, denoted as Hⁿ=Transformerₙ(Hₙ₋₁), n∈[1, N]. Each transformer layer consists of a multi-head self-attention operation followed by a feed-forward layer, formulated as Equation 1.

$${G}^{n} = LN ( MultiAttn ( {H}^{n - 1} ) + {H}^{n - 1} ) , \qquad ( 1 )$$

$${H}^{n} = LN ( FFN ( {G}^{n} ) + {G}^{n} )$$

Here, MultiAttn represents the multi-head self-attention mechanism, FFN denotes a two-layer feed-forward network, and LN represents a layer normalization operation. In the nth transformer layer, the MultiAttn is computed according to Equation 2.

$${Q}_{i} = {H}^{n - 1} {W}_{i}^{Q} , {K}_{i} = {H}^{n - 1} {W}_{i}^{K} , {V}_{i} = {H}^{n - 1} {W}_{i}^{V} , \qquad ( 2 )$$

$${head}_{i} = softmax ( \frac{{Q}_{i} {K}_{i}^{T}}{\sqrt{{d}_{k}}} + M ) {V}_{i} ,$$

$${\hat{G}}^{n} = [ {head}_{1} ; … ; {head}_{u} ] {W}_{n}^{O}$$

In Equation 2, Hⁿ⁻¹ is linearly projected into query (Qi), key (Ki), and value (Vi) using trainable parameters Wᵢ^{Q}, Wᵢ^{K}, Wᵢ^{V}, respectively. Here, dₖ represents the dimension of a head, u denotes the number of heads, and Wₙ^{O} is the model parameters. The mask matrix M is employed to prevent computation between normal tokens and <PAD> tokens, where Mᵢⱼ=0 if ith token is allowed to correlate with jth token; otherwise, it is set to −∞.

As show in FIG. 2, after the transformer layers computation, the representation vector of the <CLS> token is extracted from the last transformer layer. This vector is then passed through a fully connected layer, followed by an activation operation, to obtain the basic block embedding.

Besides the node embeddings extracted by Transformer Encoder, features of CFG edges are also considered. In the CFG, an edge represents a change in the execution path caused by a jump instruction. Intuitively, edges are categorized into three types based on the jump instruction: (1) a successful conditional jump when the condition is satisfied, (2) a failing conditional jump when the condition is not satisfied, and (3) an unconditional jump. An edge embedding layer, which generates representations for different types of edges, is used.

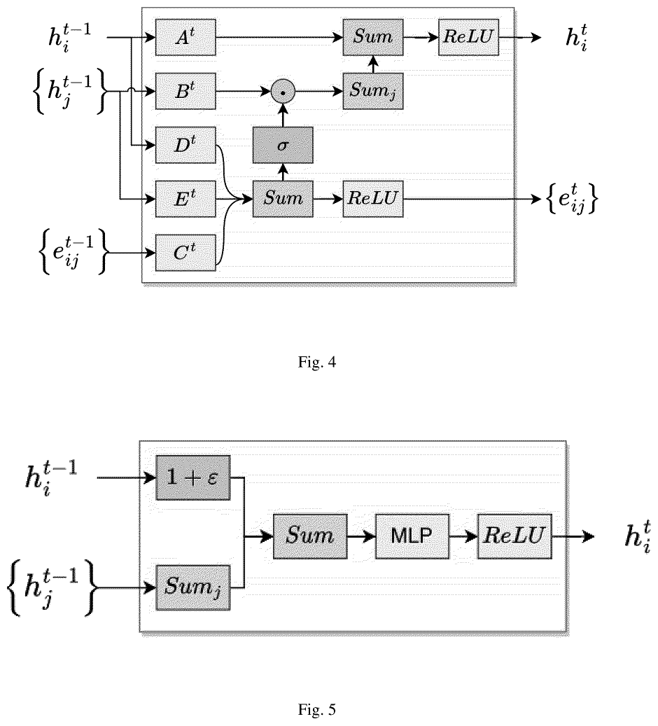

Regarding CFG Feature Encoder (GatedGCN), to compute the vector representation of CFG with n nodes, GatedGCN shown in FIG. 4 is used. GatedGCN is effective for graphs with edge features since it explicitly updates edge features along with node features. At layer t, both node i's embedding hᵢ^{t-1} and the features {eᵢⱼ^{t-1}, j∈N(i)} of the edges connecting with its neighbors are updated by considering its neighbors' embeddings {hⱼ^{t-1}, j∈N(i)}. The forward propagation within one layer of GatedGCN can be formulated as shown in Equation 3,

$${h}_{i}^{t} = ReLU ( {A}^{t - 1} {h}_{i}^{t - 1} + {\sum }_{j ∈ N ( i )} σ ( {ê}_{i j}^{t - 1} ) ⊙ {B}^{t - 1} {h}_{j}^{t - 1} ) \qquad ( 3 )$$

$${e}_{i j}^{t} = ReLU ( {C}^{t - 1} {e}_{i j}^{t - 1} + {D}^{t - 1} {h}_{i}^{t - 1} + {E}^{t - 1} {h}_{j}^{t - 1} )$$

where σ is the sigmoid function, ⊙ is the Hadamard product, A^{t-1}, B^{t-1}, C^{t-1}, D^{t-1}, E^{t-1} are linear transformation matrices.

After t layers of propagation, the updated node embeddings hᵢ^{t}, i=1, 2, . . . , n is obtained. Finally, the CFG embedding g_{cfg} is computed via an attention-based graph pooling layer show in Equation 4,

$$\text{?} .$$

$$\text{?} \text{indicates text missing or illegible when filed}$$

where n is the number of nodes in CFG and Ogate is a linear score function that transforms the node embedding into a scaler.

Regarding Node Feature Encoder, node features are extracted from two perspectives: node degrees and imported function names.

Node degree features play an important role in enabling the subsequent GNN model to capture structural information effectively, such as degree information and neighborhood connection patterns. A degree embedding strategy similar is used to degree+. In this strategy, each degree with a value less than 20 is treated as an individual class, while degrees greater than or equal to 20 are grouped into a single class since they appear rarely in out datasets. Then, an embedding layer is employed to map each degree class to a corresponding vector representation. Notably, in-degree and out-degree are treated separately, resulting in two distinct degree embeddings for each node.

Imported functions are crucial for indicating function similarity as they preserve semantic and functional information of the target function while being relatively stable across different compilation configurations. For nodes representing imported functions, their original function names are retained. In contrast, nodes representing internal functions are assigned the symbol <INTERNAL> as their function name. Subsequently, an embedding layer is used to map each node's function name to a vector representation.

The final node embedding is obtained by summing up the in-degree embedding, out-degree embedding, and imported function name embedding. The proposed node feature encoder effectively capture both structural and semantic information.

Regarding CG Subgraph Feature Encoder (GIN), the GIN model is used to compute the vector representation of the CG subgraph. The choice of GIN is motivated by the demonstration that the sum aggregator used by GIN is more expressive than the mean and max aggregators, enabling better capturing of subgraph connection patterns. In FIG. 5, the propagation process at layer t involves updating node i's embedding hᵢ^{t-1} by aggregating the embeddings of its neighbors hⱼ^{t-1}, j=N(i). This forward propagation can be described by Equation 5.

$${h}_{i}^{t} = ReLU ( {U}^{t - 1} ( ReLU ( BN ( {V}^{t - 1} {\hat{h}}_{i}^{t - 1} ) ) ) ) \qquad ( 5 )$$

$${\hat{h}}_{i}^{t - 1} = ( 1 + γ ) {h}_{i}^{t - i} + {\sum }_{j ∈ N ( i )} {h}_{j}^{t - 1}$$

Here, γ is a learnable constant, BN denotes batch normalization, and U^{t-1} and V^{t-1} are linear transformation matrices.

Finally, the CG subgraph embedding g_{cg} is obtained by applying the attention-based graph pooling layer to the node embeddings at the last layer of GIN.

Regarding Feature Fusing, as shown in Equation 6, g_{cfg} and g_{cg} are fused by concatenating and passing them through a fully-connected layer, followed by an L2 normalization operation. The resulting vector g is the final representation of the target function.

$$g = {L}_{2} Norm ( W ( {g}_{cfg} \vert \vert {g}_{gcg} ) ) \qquad ( 6 )$$

### Training Strategy

To address the random sampling limitations, hard sample-aware momentum contrastive learning is provided. This approach combines momentum contrastive learning with the MS (Multi-Similarity) Miner and MS Loss techniques. A detailed description of training strategy is provided as below.

### Require:

loader: dataloader that offers mini-batches
fq: binary function representation model
fk: momentum encoder
Q: the queue for storing features of preceding mini-batches
m: momentum

| | |
|---|---|
| 1: | ƒ_{k.}params ← ƒ_{q}.params |
| 2: | for (x, y) in loader do |
| 3: | q ← ƒ_{q}.forward(x) |
| 4: | k ← ƒₖ.forward(x).detach( ) |
| 5: | enqueue(Q, (k, y)) |
| 6: | dequeue(Q) |
| 7: | sim_matrix ← q^{T} · Q.feats |
| 8: | pos_sim, neg_sim ← MSMiner(sim_matrix, y, Q.labels) |
| 9: | loss ← MSLoss(pos_sim, neg_sim) |
| 10: | backpropagation and update ƒ_{q}.params |
| 11: | ƒₖ.params ← m × ƒₖ.params + (1 − m) × ƒ_{q}.params |
| 12: | end for |

Regarding Momentum Contrastive Learning, in this method, a memory queue is maintained to store representations of previous mini-batches. The queue size is typically much larger than the mini-batch size, allowing us to sample informative pairs not only within the same batch but also across different batches. During each training iteration, the encoded features of the current mini-batch are enqueued, while the most outdated features of the oldest mini-batch in the queue are dequeued. This process ensures that the representations stored in the queue remain consistent.

Prior to training, in addition to the binary function representation model ƒ_{q} that we aim to train, another model called the momentum encoder ƒₖ is provided. The momentum encoder is initialized with the same parameters as ƒ_{q} and is responsible for producing representations used to maintain the queue. The reason behind using a separate momentum encoder is that the original model is updated during each iteration, causing the features of different mini-batches to be generated by different models and leading to inconsistency. In contrast, the momentum encoder is updated smoothly using the momentum update shown in Equation 7.

$${θ}_{k} ← m {θ}_{k} + ( 1 - m ) {θ}_{q} \qquad ( 7 )$$

Here, θₖ represents the parameters of the momentum encoder, and θ_{q} represents the parameters of the binary function representation model. The momentum coefficient m∈[0, 1) is typically set to a relatively large value (e.g., m=0.999), ensuring that the momentum encoder updates slowly and maintains consistent embeddings in the queue.

In general, during each training step, ƒ_{q} and ƒₖ generate features q and k, respectively, for the current mini-batch. Then, the queue is updated with the new features k. The MS Miner and MS Loss are then used to compute the loss based on the similarities between q and features stored in the queue. The loss is minimized with gradient descent optimization to update ƒ_{q}. Finally, the momentum encoder ƒₖ is updated using the momentum update equation.

Regarding Hard Sample-Aware Miner and Loss, to enhance the model's ability to handle hard samples, the MS (Multi-Similarity) Miner and MS Loss are integrated into momentum contrastive learning.

The MS Miner is responsible for sampling informative pairs from the queue. Negative pairs (i.e., dissimilar pairs) are sampled by comparing to the hardest positive pairs, while positive pairs (i.e., similar pairs) are sampled by comparing to the hardest negative pairs. Let Sᵢⱼ denote the similarity between sample i and j, and yᵢ represent the label of sample i. As shown in Equation 8, the negative pairs and the positive pairs are sampled when their similarities satisfy the following two formulas respectively,

$${S}_{ij}^{-} > {min}_{{y}_{k} = {y}_{i}} {S}_{ik} - ϵ \qquad ( 8 )$$

$${S}_{ij}^{+} > {max}_{{y}_{k} \neq {y}_{i}} {S}_{ik} + ϵ$$

where ϵ is a margin. The positive pairs are selected if Sᵢⱼ satisfies.

Using the sampled informative pairs, the MS Loss function is computed as shown in Equation 9.

$$ℒ = \frac{1}{m} {\sum }_{i = 1}^{m} \{ \frac{1}{α} log [ = 1 + {\sum }_{{y}_{k} = {y}_{i}} {e}^{- α ( {S}_{ik} - λ )} ] + \frac{1}{β} log [ 1 + {\sum }_{{y}_{k} \neq {y}_{i}} {e}^{β ( {S}_{ik} - λ )} ] \} \qquad ( 9 )$$

By computing the gradient wᵢⱼ=∂L/∂Sᵢⱼ, Equation 10 is obtained. For negative pairs where yⱼ≠yᵢ, the value of wᵢⱼ increases either when the predicted similarity Sᵢⱼ between these pairs becomes larger or when the predicted similarities Sᵢₖ (yₖ≠yᵢ) for other negative pairs decrease. This suggests that harder negative pairs yield a larger gradient, contributing to the model's learning process. Likewise, the same principles apply to positive pairs. As a consequence, the model becomes more sensitive to challenging pairs, resulting in better BCSD performance.

$${w}_{ij} = \{ \begin{matrix}\frac{1}{{e}^{β ( λ − {S}_{i j} )} + {\sum }_{{y}_{k} \neq {y}_{i}} {e}^{β ( {S}_{ik} − {S}_{i j} )}} , & {y}_{j} \neq {y}_{i} \\ \frac{1}{{e}^{− α ( λ − {S}_{i j} )} + {\sum }_{{y}_{k} \neq {y}_{i}} {e}^{− α ( {S}_{ik} − {S}_{i j} )}} , & {y}_{j} = {y}_{i}\end{matrix} \qquad ( 10 )$$

### Similarity Detection Device

As shown in FIG. 1, in the one-to-many (OM) binary function search scenario, the binary code similarity detection system provided in the present embodiment generates embeddings for the target function and the function pool. Finally, the cosine similarity are calculated between the target vector and each vector within the function pool to identify the similar function.

### Parameters

In the binary code similarity detection system provided in the present embodiment, the following hyperparameters are set based on effectiveness and efficiency considerations. In the Transformer Encoder model, set layer(N)=6, num_head (u)=4, and hidden_size (dk)=128. In the GatedGCN model, use layer (t)=5 and hidden_size=128. In the GIN model, use layer=1 and hidden_size=128. The 2-hop subgraph in the call graph modeling is extracted. Set m to 0.999 and the queue size to 16,384 following for the momentum constrastive learning. Regarding MS Miner and MS Loss, use ϵ=0.1, =2, λ=1, and β=50. In the training stage, set batch size to 30. To construct each mini-batch, randomly sample 6 classes with each contributing 5 samples. Here, it is important to note that samples originating from the same class are those that have been compiled from the same source code. For optimization, the Adam optimizer and the Linear Warmup scheduler with an initial learning rate of 10⁻³ and a warmup ratio of 0.15 are used. The total number of training steps is set to 300,000.

### Datasets

To enhance the credibility of results, two widely-used datasets: BINKIT and BFS are used for performance evaluation.

BINKIT comprises 51 GNU software packages commonly utilized in Linux systems, while BFS consists of 7 diverse projects including UnRAR-5.5.3, ClamAV-0.102.0, Curl-7.67.0, Nmap-7.80, OpenSSL-3.0, Zlib-1.2.11, and Z3-4.8.7. These projects are compiled for three architectures: x86, arm, and mips, in both 32-bit and 64-bit versions, resulting in a total of 6 architecture variations. Two versions of compilers, namely gcc-9 and clang-9, including 5 optimization levels (O0, O1, O2, O3, and Os), are provided. Consequently, each function can have up to 60 variants (i.e., 60 compilation configurations) theoretically. Functions with less than five basic blocks are excluded. Additionally, functions with less than five variants are filtered out to ensure an adequate number of positive pairs for training. Both datasets are divided into training, validation, and testing sets based on the project to which each function belongs. This ensures that the binaries used for evaluation are entirely unseen by the model during the training phase. Table 1 presents the number of projects, binaries, and functions in each dataset split.

TABLE 1
Statistics regarding the number of projects, binaries, and functions
in the BINKIT and BFS datasets.

| Datasets | Split | # Projects | # Binaries | # Functions |
|---|---|---|---|---|
| BINKIT | Train | 21 | 5,220 | 729,044 |
| | Validation | 9 | 6,840 | 98,061 |
| | Test | 21 | 2,760 | 309,559 |
| BFS | Train | 3 | 359 | 868,191 |
| | Validation | 1 | 60 | 37,610 |
| | Test | 3 | 970 | 487,063 |

From the test datasets, four test tasks are constructed as the follows. (1) XO: the function pairs have the same configurations except for the optimization level. (2) XC: the function pairs have different compilers and optimizations, but the same architecture and bitness. (3) XA: the function pairs have different architectures and bitnesses, but the same compiler and optimization. (4) XM: the function pairs are selected arbitrarily from different compilers, optimizations, architectures, and bitnesses. Each task consists of 10,000 times of similarity search, with each search comprising a target function and a function pool. The model's objective is to identify the only one function in the pool that is similar to the target function.

### Baselines

The binary code similarity detection system provided in the present embodiment is compared against five top-performing baselines including Gemini, SAFE, GraphEmb, Graph Matching Networks (GMN) and jTrans.

Gemini is provided by Xiaojun Xu etc. This method extracts manually crafted features for basic blocks and employs a GNN to generate vector representations of binary functions. Gemini is a seminal work that introduces GNNs with the contrastive learning into BCSD.

SAFE is provided by Luca Massarelli etc. This baseline is an NLP-based method, which utilizes a word2vec model to generate instruction embeddings and employs a self-attentive network to extract function embeddings.

GraphEmb is provided by Luca Massarelli etc. This method employs word2vec to learn instruction embeddings and uses an RNN to generate basic blocks' embeddings. It then uses a GNN to generate function embeddings.

Graph Matching Networks (GMN) is provided by Yujia Li etc. This baseline proposes a novel graph matching model for directly calculating the similarity between a pair of graphs. Recent studies have shown that GMN performs the best in both the Binary Code Search and vulnerability discovery tasks.

jTrans is provided by Hao Wang etc. This baseline introduces a novel pre-trained Jump Aware Transformer that incorporates control-flow information into the Transformer architecture. Since it is based on x86 architecture, its vocabulary and the embedding layer are expanded to align with the datasets. The publicly released pre-trained model1 is fine-tuned.

All the above baselines are carefully reimplemented using PyTorch based on their official source code and keep their default parameter settings for evaluation.

### Evaluation Metrics

In the binary code similarity detection system provided in the present embodiment, to measure the performance in OM scenario, two evaluation metrics of mean reciprocal rank (MRR) and recall at different k thresholds (Recall@k) are used.

Let P={^{\hat{ }}ƒ1, ^{\hat{ }}ƒ2, . . . , ^{\hat{ }}ƒp} represent the pool of binary functions, and Q={ƒ1, ƒ2, . . . , ƒ_{q}} denote the set of query functions. For each function ƒi∈Q, there exists a corresponding similar function ^{\hat{ }}ƒi=P. The BCSD task involves ranking the function pool P based on the similarities between ƒi and {^{\hat{ }}ƒj|j=1, 2, . . . , p}. R_{\hat{ }ƒi} is denoted as the position of ^{\hat{ }ƒ}ᵢ in the ranked function pool. The MRR and Recall@k can be calculated using Equation 11 and Equation 12, respectively, where I is the indicator function which is 1 if the condition is true otherwise 0.

$$MRR = \frac{1}{\vert 𝒬 \vert} {\sum }_{{f}_{i} ∈ 𝒬} \frac{1}{{R}_{{\hat{f}}_{i}}} \qquad ( 11 )$$

$$Recall @ k \frac{1}{\vert 𝒬 \vert} {\sum }_{{f}_{i} ∈ 𝒬} 𝕀 ( {R}_{{\hat{f}}_{i}} \leq k ) \qquad ( 12 )$$

### Experimental Results

### Evaluation on BCSD

A comprehensive evaluation of baselines and the binary code similarity detection system provided in the present embodiment is conducted on the four test tasks (i.e., XO, XC, XA, and XM) using different pool sizes as described above. The evaluation is performed on both BINKIT and BFS datasets. The results for a pool size of 1,000 are summarized in Table 2 and Table 3. The binary code similarity detection system provided in the present embodiment is named BinMoCo.

TABLE 2
Performance comparison of different BCSD methods on BINKIT (pool size = 1,000).

| | MRR | | | | Recall@1 | | | | Recall@5 | | | |
|---|---|---|---|---|---|---|---|---|---|---|---|---|
| Models | XO | XC | XA | XM | XO | XC | XA | XM | XO | XC | XA | XM |
| Gemini | 0.644 | 0.550 | 0.766 | 0.489 | 0.559 | 0.448 | 0.685 | 0.384 | 0.738 | 0.668 | 0.866 | 0.604 |
| SAFE | 0.596 | 0.481 | 0.512 | 0.366 | 0.494 | 0.353 | 0.371 | 0.236 | 0.717 | 0.627 | 0.685 | 0.509 |
| GraphEmb | 0.629 | 0.527 | 0.662 | 0.423 | 0.539 | 0.417 | 0.553 | 0.307 | 0.733 | 0.655 | 0.795 | 0.553 |
| GMN | 0.731 | 0.658 | 0.817 | 0.592 | 0.644 | 0.556 | 0.735 | 0.479 | 0.837 | 0.781 | 0.917 | 0.724 |
| jTrans | 0.812 | 0.766 | 0.831 | 0.679 | 0.731 | 0.671 | 0.744 | 0.565 | 0.910 | 0.885 | 0.942 | 0.820 |
| BinMoCo | 0.897 | 0.878 | 0.908 | 0.836 | 0.844 | 0.819 | 0.855 | 0.765 | 0.962 | 0.949 | 0.970 | 0.922 |
| BinMoCo w/o C | 0.872 | 0.849 | 0.900 | 0.824 | 0.812 | 0.783 | 0.842 | 0.752 | 0.946 | 0.928 | 0.969 | 0.911 |
| BinMoCo w/o M | 0.879 | 0.851 | 0.890 | 0.795 | 0.821 | 0.783 | 0.828 | 0.713 | 0.950 | 0.934 | 0.965 | 0.897 |
| BinMoCo w/o S | 0.876 | 0.846 | 0.877 | 0.780 | 0.817 | 0.779 | 0.812 | 0.694 | 0.948 | 0.930 | 0.956 | 0.888 |
| BinMoCo-R | 0.833 | 0.788 | 0.843 | 0.718 | 0.762 | 0.704 | 0.767 | 0.617 | 0.920 | 0.889 | 0.936 | 0.842 |

TABLE 3
Performance comparison of different BCSD methods on BFS (pool size = 1,000).

| | MRR | | | | Recall@1 | | | | Recall@5 | | | |
|---|---|---|---|---|---|---|---|---|---|---|---|---|
| Models | XO | XC | XA | XM | XO | XC | XA | XM | XO | XC | XA | XM |
| Gemini | 0.758 | 0.533 | 0.778 | 0.492 | 0.704 | 0.445 | 0.706 | 0.396 | 0.817 | 0.628 | 0.865 | 0.602 |
| SAFE | 0.655 | 0.355 | 0.309 | 0.202 | 0.594 | 0.263 | 0.200 | 0.107 | 0.718 | 0.443 | 0.418 | 0.287 |
| GraphEmb | 0.716 | 0.422 | 0.474 | 0.286 | 0.664 | 0.333 | 0.369 | 0.188 | 0.772 | 0.510 | 0.594 | 0.386 |
| GMN | 0.778 | 0.582 | 0.775 | 0.528 | 0.718 | 0.486 | 0.694 | 0.420 | 0.850 | 0.695 | 0.878 | 0.648 |
| jTrans | 0.842 | 0.688 | 0.742 | 0.562 | 0.791 | 0.600 | 0.653 | 0.452 | 0.903 | 0.793 | 0.851 | 0.692 |
| BinMoCo | 0.953 | 0.892 | 0.946 | 0.859 | 0.932 | 0.852 | 0.917 | 0.805 | 0.980 | 0.942 | 0.981 | 0.924 |
| BinMoCo w/o C | 0.939 | 0.876 | 0.951 | 0.850 | 0.913 | 0.832 | 0.925 | 0.796 | 0.970 | 0.929 | 0.981 | 0.914 |
| BinMoCo w/o M | 0.935 | 0.852 | 0.907 | 0.788 | 0.907 | 0.799 | 0.861 | 0.716 | 0.970 | 0.917 | 0.964 | 0.877 |
| BinMoCo w/o S | 0.918 | 0.803 | 0.846 | 0.713 | 0.885 | 0.737 | 0.787 | 0.627 | 0.957 | 0.885 | 0.917 | 0.816 |
| BinMoCo-R | 0.883 | 0.743 | 0.804 | 0.644 | 0.841 | 0.662 | 0.725 | 0.542 | 0.935 | 0.841 | 0.902 | 0.767 |

The results show that the binary code similarity detection system provided in the present embodiment outperforms all baselines by a significant margin. Specifically, in XM task of the BINKIT dataset, the best-performing baseline, jTrans, achieves an MRR score of 0.679, while the binary code similarity detection system provided in the present embodiment achieves an MRR score of 0.836, representing a 23% performance improvement. Additionally, the binary code similarity detection system provided in the present embodiment exhibits stable performance across the XO, XC and XA tasks, with only a modest 0.03 to 0.05 performance drop from XA to XO and XC. This stands in contrast to the CFG-based methods (i.e., Gemini, GraphEmb, GMN, and jTrans) that show varying effectiveness across the three tasks due to their sensitivity to changes in compilers and optimization levels. This stability is attributed to the fact that call graphs remain relatively stable across different compilers and optimization levels.

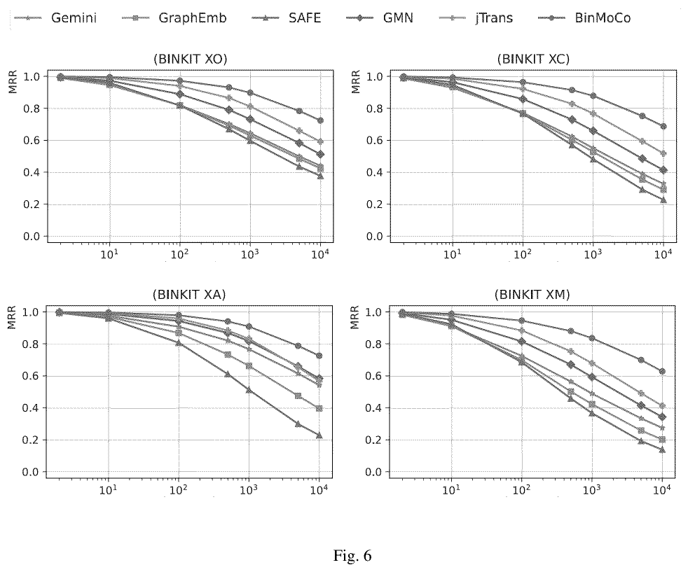

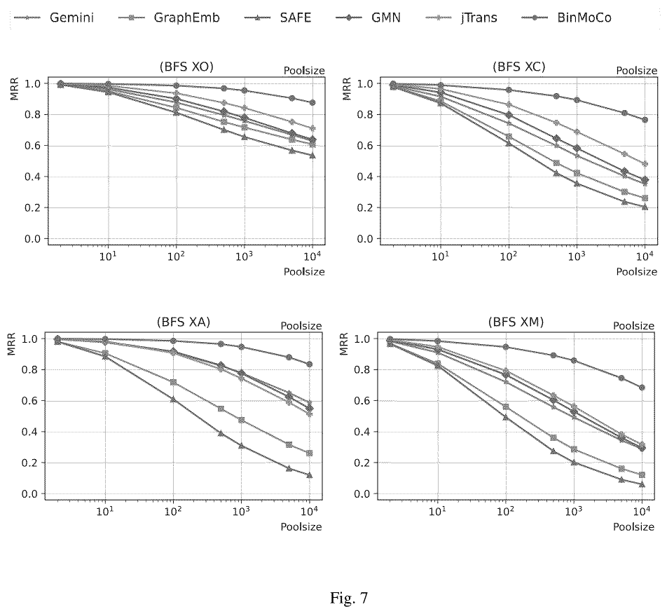

The effect of pool size on model performance, which is important since pool size is generally large in real-world BCSD applications, is further investigated. Set pool size to 2, 10, 100, 500, 1000, 5000, 10000 and plot the MRR scores on BINKIT and BFS. The results are shown in FIGS. 6 and 7. The results reveal that at very small pool sizes (e.g., 2), the performance of baselines is comparable to that of the binary code similarity detection system provided in the present embodiment. However, as the pool size increases, advantage of the binary code similarity detection system provided in the present embodiment becomes increasingly apparent, particularly when the pool size exceeds 100. For example, in the challenging XM task of the BFS dataset, the binary code similarity detection system provided in the present embodiment achieves an MRR score of 0.684, more than twice the MRR score of the best-performing baseline, jTrans, at 0.316. The results highlight effectiveness of the binary code similarity detection system provided in the present embodiment particularly under large pool sizes, as well as its ability to maintain relatively stable performance as the pool size increases.

Therefore, the binary code similarity detection system provided in the present embodiment is the most effective one across all four test tasks and both datasets, showcasing the advancement of the binary code representation model and training strategy.

### Evaluation on Known Vulnerability Detection

Vulnerability detection is a crucial application in the field of computer security. In this experiment, real-world dataset is used to assess the known vulnerability detection capability of the binary code similarity detection system provided in the present embodiment. The dataset consists of ten vulnerable functions extracted from OpenSSL 1.0.2d, covering a total of eight Common Vulnerabilities and Exposures (CVEs). These functions are compiled for four different architectures: x86, x64, arm32, and mips32. Additionally, the dataset includes two firmware images, namely Netgear R7000 (arm32) and TP-Link Deco M4 (mips32), which contain the aforementioned vulnerable functions. Both firmware images serve as large function pools with pool sizes of 3,916 and 3,566, respectively. The objective is to search the vulnerable functions from these two firmware images.

The MRR metric is used to evaluate the vulnerability search task, and the results are presented in Table 4.

TABLE 4
MRR comparison on known vulnerability detection.

| | Netgear R7000 (arm32) | | | | | TP-Link Deco-M4 (mips32) | | | | |
|---|---|---|---|---|---|---|---|---|---|---|
| Models | x86 | x64 | arm32 | mips32 | Average | x86 | x64 | arm32 | mips32 | Average |
| Gemini | 1.000 | 0.875 | 0.875 | 0.633 | 0.846 | 0.428 | 0.448 | 0.568 | 0.433 | 0.469 |
| SAFE | 0.157 | 0.047 | 0.560 | 0.320 | 0.271 | 0.307 | 0.833 | 0.362 | 0.690 | 0.548 |
| GraphEmb | 0.291 | 0.276 | 0.628 | 0.269 | 0.366 | 0.687 | 0.708 | 0.436 | 0.570 | 0.600 |
| GMN | 0.688 | 0.833 | 0.875 | 0.383 | 0.695 | 0.792 | 0.889 | 0.778 | 0.843 | 0.825 |
| jTrans | 0.572 | 0.875 | 1.000 | 0.646 | 0.773 | 0.774 | 0.854 | 0.743 | 0.917 | 0.822 |
| BinMoCo | 1.000 | 1.000 | 1.000 | 0.688 | 0.922 | 0.792 | 0.917 | 0.764 | 0.867 | 0.835 |

On average, the binary code similarity detection system provided in the present embodiment achieves the highest performance in detecting vulnerabilities from both target images. The results that the binary code similarity detection system provided in the present embodiment consistently outperforms the baselines for all eight CVEs. For the first seven CVEs, the binary code similarity detection system provided in the present embodiment successfully retrieves all the variants within the top-5 ranking list. Although the binary code similarity detection system provided in the present embodiment falls short of detecting all the vulnerable functions within the top-5 list for CVE-2016-0797, it still achieves a recall@5 of 87.5%, surpassing or equaling the performance of all the baselines.

Therefore, the binary code similarity detection system provided in the present embodiment can detect the vast majority of vulnerabilities in the top-5 ranking list, which outperforms all the baselines, demonstrating that it is an effective and applicable method for detecting real-world known vulnerabilities.

### REFERENCES

Sunwoo Ahn, Seonggwan Ahn, Hyungjoon Koo, and Yunheung Paek. 2022. Practical Binary Code Similarity Detection with BERT-based Transferable Similarity Learning. In Proceedings of the 38th Annual Computer Security Applications Conference. 361-374.
Aisha Ali-Gombe, Irfan Ahmed, Golden G Richard III, and Vassil Roussev. 2015. Opseq: Android malware fingerprinting. In Proceedings of the 5th Program Protection and Reverse Engineering Workshop. 1-12.
Martial Bourquin, Andy King, and Edward Robbins. 2013. Binslayer: accurate comparison of binary executables. In Proceedings of the 2nd ACM SIGPLAN Program Protection and Reverse Engineering Workshop. 1-10.
Mahinthan Chandramohan, Yinxing Xue, Zhengzi Xu, Yang Liu, Chia Yuan Cho, and Hee Beng Kuan Tan. 2016. Bingo: Cross-architecture cross-os binary search. In Proceedings of the 2016 24th ACM SIGSOFT International Symposium on Foundations of Software Engineering. 678-689.
Yiran Cheng, Shouguo Yang, Zhe Lang, Zhiqiang Shi, and Limin Sun. 2023. VERI: A Large-scale Open-Source Components Vulnerability Detection in IoT Firmware. Computers & Security 126 (2023), 103068.
Hejie Cui, Zijie Lu, Pan Li, and Carl Yang. 2022. On positional and structural node features for graph neural networks on non-attributed graphs. In Proceedings of the 31st ACM International Conference on Information & Knowledge Management. 3898-3902.
Yaniv David, Nimrod Partush, and Eran Yahav. 2016. Statistical similarity of binaries. Acm sigplan notices 51, 6 (2016), 266-280.
Yaniv David, Nimrod Partush, and Eran Yahav. 2017. Similarity of Binaries through Re-Optimization. In Proceedings of the 38th ACM SIGPLAN Conference on Programming Language Design and Implementation (Barcelona, Spain) (PLDI 2017). Association for Computing Machinery, New York, NY, USA, 79-94. https://doi.org/10.1145/3062341.3062387
Jacob Devlin, Ming-Wei Chang, Kenton Lee, and Kristina Toutanova. 2019. BERT: Pre-training of Deep Bidirectional Transformers for Language Understanding. In Proceedings of the 2019 Conference of the North American Chapter of the Association for Computational Linguistics: Human Language Technologies, NAACL-HLT 2019, Minneapolis, MN, USA, Jun. 2-7, 2019, Volume 1 (Long and Short Papers), Jill Burstein, Christy Doran, and Thamar Solorio (Eds.). Association for Computational Linguistics, 4171-4186. https://doi.org/10.18653/v1/n19-1423
Steven H H Ding, Benjamin C M Fung, and Philippe Charland. 2016. Kam1n0: Mapreduce-based assembly clone search for reverse engineering. In Proceedings of the 22nd ACM SIGKDD international conference on knowledge discovery and data mining. 461-470.
Steven H H Ding, Benjamin C M Fung, and Philippe Charland. 2019. Asm2vec: Boosting static representation robustness for binary clone search against code obfuscation and compiler optimization. In 2019 IEEE Symposium on Security and Privacy (SP). IEEE, 472-489.
Thomas Dullien and Rolf Rolles. 2005. Graph-based comparison of executable objects (english version). Sstic 5, 1 (2005), 3.
Vijay Prakash Dwivedi, Chaitanya K Joshi, Thomas Laurent, Yoshua Bengio, and Xavier Bresson. 2020. Benchmarking graph neural networks. (2020).
Manuel Egele, Maverick Woo, Peter Chapman, and David Brumley. 2014. Blanket Execution: Dynamic Similarity Testing for Program Binaries and Components. In 23rd USENIX Security Symposium (USENIX Security 14). USENIX Association, San Diego, CA, 303-317.
Sebastian Eschweiler, Khaled Yakdan, and Elmar Gerhards-Padilla. 2016. dis covRE: Efficient Cross-Architecture Identification of Bugs in Binary Code. In 23rd Annual Network and Distributed System Security Symposium, NDSS 2016, San Diego, California, USA, Feb. 21-24, 2016. The Internet Society.
Qian Feng, Rundong Zhou, Chengcheng Xu, Yao Cheng, Brian Testa, and Heng Yin. 2016. Scalable graph-based bug search for firmware images. In Proceedings of the 2016 ACM SIGSAC Conference on Computer and Communications Security. 480-491.
Matthias Fey and Jan Eric Lenssen. 2019. Fast graph representation learning' with PyTorch Geometric. arXiv preprint arXiv: 1903.02428 (2019).
Debin Gao, Michael K Reiter, and Dawn Song. 2008. Binhunt: Automatically finding semantic differences in binary programs. In Information and Communications Security: 10th International Conference, ICICS 2008 Birmingham, UK, Oct. 20-22, 2008 Proceedings 10. Springer, 238-255.
Jian Gao, Xin Yang, Ying Fu, Yu Jiang, and Jiaguang Sun. 2018. VulSeeker: A semantic learning based vulnerability seeker for cross-platform binary. In Proceedings of the 33rd ACM/IEEE International Conference on Automated Software Engineering. 896-899.
Kaiming He, Haoqi Fan, Yuxin Wu, Saining Xie, and Ross Girshick. 2020. Momentum contrast for unsupervised visual representation learning. In Proceedings of the IEEE/CVF conference on computer vision and pattern recognition. 9729-9738.
Xin Hu, Kang G Shin, Sandeep Bhatkar, and Kent Griffin. 2013. Mutantx-s: Scalable malware clustering based on static features. In 2013 {USENIX} Annual Technical Conference ({USENIX} {ATC} 13). 187-198
Yikun Hu, Yuanyuan Zhang, Juanru Li, Hui Wang, Bodong Li, and Dawu Gu. 2018. BinMatch: A Semantics-Based Hybrid Approach on Binary Code Clone Analysis. In 2018 IEEE International Conference on Software Maintenance and Evolution (ICSME). 104-114. https://doi.org/10.1109/ICSME.2018.00019
Yoon-Chan Jhi, Xinran Wang, Xiaoqi Jia, Sencun Zhu, Peng Liu, and Dinghao Wu. 2011. Value-based program characterization and its application to soft ware plagiarism detection. In Proceedings of the 33rd international conference on software engineering. 756-765.
Wei Ming Khoo, Alan Mycroft, and Ross Anderson. 2013. Rendezvous: A search engine for binary code. In 2013 10th Working Conference on Mining Software Repositories (MSR). IEEE, 329-338.
Dongkwan Kim, Eunsoo Kim, Sang Kil Cha, Sooel Son, and Yongdae Kim. 2022. Revisiting binary code similarity analysis using interpretable feature engineering and lessons learned. IEEE Transactions on Software Engineering (2022).
Diederik P Kingma and Jimmy Ba. 2014. Adam: A method for stochastic optimization. arXiv preprint arXiv: 1412.6980 (2014).
Yeo Reum Lee, BooJoong Kang, and Eul Gyu Im. 2013. Function Matching-Based Binary-Level Software Similarity Calculation. In Proceedings of the 2013 Research in Adaptive and Convergent Systems (Montreal, Quebec, Canada) (RACS '13). Association for Computing Machinery, New York, NY, USA, 322-327. https://doi.org/10.1145/2513228.2513300
Yujia Li, Chenjie Gu, Thomas Dullien, Oriol Vinyals, and Pushmeet Kohli. 2019. Graph matching networks for learning the similarity of graph structured objects. In International conference on machine learning. PMLR, 3835-3845.
Bingchang Liu, Wei Huo, Chao Zhang, Wenchao Li, Feng Li, Aihua Piao, and Wei Zou. 2018. adiff: cross-version binary code similarity detection with dnn. In Proceedings of the 33rd ACM/IEEE International Conference on Automated Software Engineering. 667-678.
Yinhan Liu, Myle Ott, Naman Goyal, Jingfei Du, Mandar Joshi, Danqi Chen, Omer Levy, Mike Lewis, Luke Zettlemoyer, and Veselin Stoyanov. 2019. ROBERTa: A Robustly Optimized BERT Pretraining Approach. CoRR abs/1907.11692 (2019). arXiv: 1907.11692 http://arxiv.org/abs/1907.11692
Zhenhao Luo, Pengfei Wang, Baosheng Wang, Yong Tang, Wei Xie, Xu Zhou, Danjun Liu, and Kai Lu. [n.d.]. VulHawk: Cross-architecture Vulnerability Detection with Entropy-based Binary Code Search. ([n. d.]).
Andrea Marcelli, Mariano Graziano, Xabier Ugarte-Pedrero, Yanick Fratantonio, Mohamad Mansouri, and Davide Balzarotti. 2022. How machine learning is solv ing the binary function similarity problem. In 31st USENIX Security Symposium (USENIX Security 22). 2099-2116.
Luca Massarelli, Giuseppe Antonio Di Luna, Fabio Petroni, Roberto Baldoni, and Leonardo Querzoni. 2019. Safe: Self-attentive function embeddings for binary similarity. In Detection of Intrusions and Malware, and Vulnerability Assessment: 16th International Conference, DIMVA 2019, Gothenburg, Sweden, Jun. 19-20, 2019, Proceedings 16. Springer, 309-329.
Luca Massarelli, Giuseppe A Di Luna, Fabio Petroni, Leonardo Querzoni, and Roberto Baldoni. 2019. Investigating graph embedding neural networks with unsupervised features extraction for binary analysis. In Proceedings of the 2nd Workshop on Binary Analysis Research (BAR). 1-11.
Luca Massarelli, Giuseppe Antonio Di Luna, Fabio Petroni, Leonardo Querzoni, and Roberto Baldoni. 2021. Function representations for binary similarity. IEEE Transactions on Dependable and Secure Computing 19, 4 (2021), 2259-2273.
Adam Paszke, Sam Gross, Francisco Massa, Adam Lerer, James Bradbury, Gregory Chanan, Trevor Killeen, Zeming Lin, Natalia Gimelshein, Luca Antiga, et al. 2019. Pytorch: An imperative style, high-performance deep learning library. Advances in neural information processing systems 32 (2019).
Kexin Pei, Zhou Xuan, Junfeng Yang, Suman Jana, and Baishakhi Ray. 2020. Trex: Learning execution semantics from micro-traces for binary similarity. arXiv preprint arXiv: 2012.08680 (2020).
radare org. 2023. Radare2: Libre Reversing Framework for Unix Geeks. https://github.com/radareorg/radare2
Andreas Sæbjørnsen, Jeremiah Willcock, Thomas Panas, Daniel Quinlan, and Zhendong Su. 2009. Detecting Code Clones in Binary Executables. In Proceedings of the Eighteenth International Symposium on Software Testing and Analysis (Chicago, IL, USA) (ISSTA '09). Association for Computing Machinery, New York, NY, USA, 117-128. https://doi.org/10.1145/1572272.1572287
Hao Wang, Wenjie Qu, Gilad Katz, Wenyu Zhu, Zeyu Gao, Han Qiu, Jianwei Zhuge, and Chao Zhang. 2022. jTrans: jump-aware transformer for binary code similarity detection. In Proceedings of the 31st ACM SIGSOFT International Symposium on Software Testing and Analysis. 1-13.
Xun Wang, Xintong Han, Weilin Huang, Dengke Dong, and Matthew R Scott. 2019. Multi-similarity loss with general pair weighting for deep metric learning. In Proceedings of the IEEE/CVF conference on computer vision and pattern recognition. 5022-5030.
Thomas Wolf, Lysandre Debut, Victor Sanh, Julien Chaumond, Clement De langue, Anthony Moi, Pierric Cistac, Tim Rault, Rémi Louf, Morgan Funtowicz, Joe Davison, Sam Shleifer, Patrick von Platen, Clara Ma, Yacine Jernite, Julien Plu, Canwen Xu, Teven Le Scao, Sylvain Gugger, Mariama Drame, Quentin Lhoest, and Alexander M. Rush. 2020. Transformers: State-of-the-Art Natural Language Processing. In Proceedings of the 2020 Conference on Empirical Methods in Natural Language Processing: System Demonstrations. Association for Computational Lin guistics, Online, 38-45. https://www.aclweb.org/anthology/2020.emnlp-demos.6
Chao-Yuan Wu, R Manmatha, Alexander J Smola, and Philipp Krahenbuhl. 2017. Sampling matters in deep embedding learning. In Proceedings of the IEEE international conference on computer vision. 2840-2848.
Keyulu Xu, Weihua Hu, Jure Leskovec, and Stefanie Jegelka. 2019. How Powerful are Graph Neural Networks?. In International Conference on Learning Representations.
Xiaojun Xu, Chang Liu, Qian Feng, Heng Yin, Le Song, and Dawn Song. 2017. Neural network-based graph embedding for cross-platform binary code similarity detection. In Proceedings of the 2017 ACM SIGSAC conference on computer and communications security. 363-376.

1. A binary code similarity detection system based on hard sample-aware momentum contrastive learning, comprising:
a preprocessing device for transforming the binary code into tokens for neural networks;
a feature extracting device for using the tokens to generate final representation embeddings for the binary code; and
a similarity detection device for using the representation embeddings to detect the binary code similarity.

2. The binary code similarity detection system of claim 1, wherein the preprocessing device comprises:
a disassembling unit for disassembling the binary code to generate assembly tokens; and
a normalization unit for performing normalization to the assembly tokens to avoid out-of-vocabulary problem.

3. The binary code similarity detection system of claim 2, wherein the disassembling unit is configured to assign mnemonic and operand types to the corresponding tokens.

4. The binary code similarity detection system of claim 1, wherein the feature extracting device comprises:
a CFG features extractor for using tokens to extract features of control flow graph;
a CG features extractor for using tokens to extract features of call graph; and
a features combiner for combining the features of control flow graph and call graph to generate the representation embeddings for the binary code.

5. The binary code similarity detection system of claim 4, wherein the CFG features extractor comprises:
a transformer encoder unit for extracting semantic features to generate a vectorized CFG; and
a CFG feature encoder unit for converting the vectorized CFG into a vector representation.

6. The binary code similarity detection system of claim 4, wherein the CG features extractor comprises:
a node feature encoder unit for generating node embeddings; and
a CG subgraph feature encoder unit for extracting the subgraph's vector representation.

7. The binary code similarity detection system of claim 4, wherein the features combiner comprises a fully-connected layer and an L2 normalization operation unit.

8. The binary code similarity detection system of claim 4, wherein the feature processing device is configured to use a training strategy combining momentum contrastive learning with a Multi-Similarity Miner and Loss method.

9. The binary code similarity detection system of claim 8, wherein momentum contrastive learning is configured to maintain a memory queue to store representations of previous mini-batches.

10. The binary code similarity detection system of claim 8, wherein the Multi-Similarity Mine is configured to sample informative pairs from the queue.

11. The binary code similarity detection system of claim 1, wherein the similarity detection device is configured to calculate the cosine similarity of the representation embeddings.
